(19) United States
(12) Patent Application Publication
(10) Pub. No.: US 2011/0217518 A1
(43) Pub. Date: Sep. 8, 2011

(54) Reduced cost fluorescent coated posterboard

(76) Inventor: Richard J. Repecki, West Harrison, NY (US)

(21) Appl. No.: 12/932,618

(22) Filed: Feb. 28, 2011

Related U.S. Application Data
(60) Provisional application No. 61/339,018, filed on Feb. 26, 2010.

(51) Int. Cl. B32B 23/08; B05D 1/36; B32B 23/04

(52) U.S. Cl. 428/165; 427/210

(57) ABSTRACT

Colored posterboard and particularly fluorescent colored posterboard is economically produced by utilizing a paperboard substrate of all or substantially all recycled materials with a first base coat on each side of the paperboard substrate. The base coat includes clay and a binder and is applied to smooth out surface irregularities and substantially cover darker mottled coloration of the substrate. The one or more base coats do not require the color pigments but may include whiteners. A top coat including color pigment, is applied at a low coating rate of 3 to 5 lbs over the base coat such that the posterboard has good coloration without high expense of color pigments. The saving is greatest when using fluorescent pigments.

### RELATED APPLICATION

This application claims priority to my U.S. Provisional Application Ser. No. 61/339,018 filed Feb. 26, 2010.

### FIELD OF THE INVENTION

The invention herein relates to a reduced cost coated posterboard and especially a posterboard having fluorescent color.

### BACKGROUND OF THE INVENTION

Colored posterboard is well known as is providing fluorescent colored poster board. Typical colored posterboard has a paperboard substrate in the range of 8-20 points, and 16 point stock is commonly used. A colored coating is applied to the substrate to provide the color, generally to both sides thereof. The coat weight has generally been about 7-15 pounds per 500 sheets of posterboard, each sheet measuring 25 inches by 38 inches. Coating weight is at the higher end of the range for rougher or dark substrates. The coating is in general clay and a pigment or dye in an adhesive or other binder. The pigments may include a brightening agent, such as titanium dioxide. When the pigments are for fluorescent colors, they are considerably more expensive. A coating with fluorescent pigments may typically cost five or more times more than a white or non-fluorescent color coating.

The paperboard substrate has generally been a mixture of virgin pulp and pulp from recycled materials. In general, if the paperboard has a higher content of recycled material, it tends to be darker and requires either bleach or an extra coating load to achieve the desired color intensity and brightness. Of course, for ecological reasons, it is preferred to use paperboard from recycled materials and to avoid bleaching.

Paperboard substrates made from recycled materials tend to be rougher, as well as darker and more mottled. They also require heavy coating loads to achieve a posterboard with a smooth surface. From an economic standpoint it would be desirable to avoid the need for a heavy coating load to achieve a smooth posterboard product with a smooth surface the desired color intensity and brightness.

### SUMMARY OF THE INVENTION

A colored posterboard and particularly a fluorescent colored according to the invention herein has a paperboard substrate formed of all or substantially all recycled materials with one or more first coatings applied thereto at coating weights sufficient to provide substantially even coverage on the surface of the substrate and to form a relatively smooth surface, but without the desired color or fluorescent color. A top coating with color or fluorescent pigments is applied over the first coating at a coating rate of between 3 to 7 pounds and preferably 3-5 pounds. Both surfaces of the substrate may be coated in this manner.

According to certain aspects of the invention, the first coating may be white and may include a brightening agent.

In other aspects of the invention, the paperboard substrate is made of recycled materials or substantially recycled materials. In a further aspect, the materials used in fabricating the paperboard substrate are not bleached or otherwise contaminated with environmentally harmful substances.

Other more specific objects and features of the invention will appear in the following detailed description, taken together with the drawings.

### BRIEF DESCRIPTION OF THE DRAWINGS

FIG. 1 is a sectional view of a prior art posterboard;

FIG. 2 is a cross-sectional view of posterboard according to the invention herein; and

FIG. 3 is a cross-sectional view of another posterboard according to the invention herein.

The same reference numerals refer to the same elements throughout the various figures.

### DETAILED DESCRIPTION OF THE INVENTION

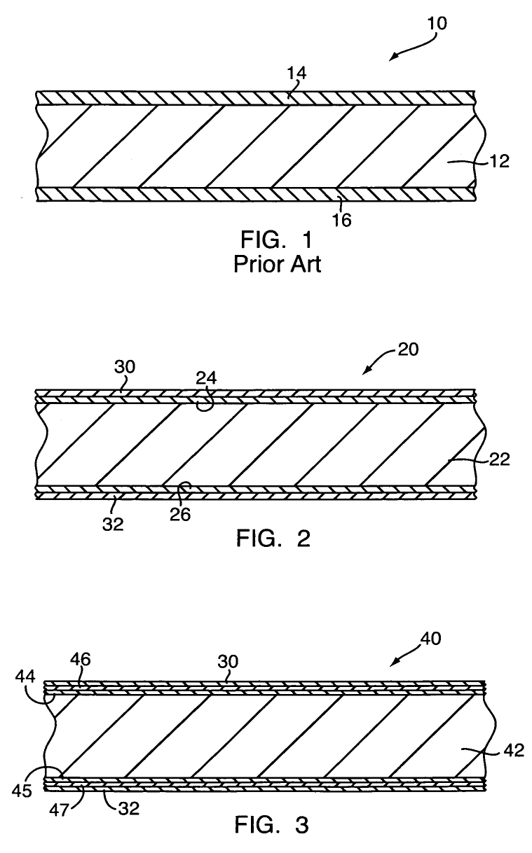

With reference to FIG. 1, a prior art posterboard 10 generally consists of a paperboard substrate 12 having a coating 14 on one surface thereof and a coating 16 on the other surface thereof. The coatings 14 and 16 are generally the same in composition and coating weight, but may be different colors.

The paperboard substrate 12 is generally fabricated of a combination of virgin pulp and pulp from recycled materials. If the content of recycled materials would result in a surface having an extensively mottled or dark surface, the pulps are bleached to result in a lighter more uniform surface. The substrate may be calendared for smoothness.

The coating 14 contains pigments or dyes, coating binders and clays. The coating is applied at the rate of about 7 to 15 pounds per 500 sheets of 25×38 posterboard. Coating weights at the higher end of the range are often necessary to achieve a coated surface that has a desired smoothness, color intensity and brightness of a high quality posterboard product. The higher coating weights are particularly necessary to compensate for mottled or dark coloration of the surface of the substrate 12, or for irregularities and unevenness thereof, when the substrate is partially made from recycled materials.

The coating 16 is applied at similar coating weights, with the same considerations. The coating 16 may have the same or a different color than the coating 14. Both of the coatings may be white if desired, and one or the both of the coatings may be colored, such as red, blue, yellow, orange, etc.

When the color of the coatings 14 and 16 is a fluorescent color, the coatings necessarily contain substantial amounts of fluorescent pigments. These are expensive when compared to the cost of the pigments and dyes for non-fluorescent color coatings. The cost of a fluorescent color coating is typically about five to six times the cost of a non-fluorescent color coating. Although substrates made of recycled or substantially recycled materials are less expensive than substrates with a substantial percentage of virgin fibers, the cost and ecological benefits of using recycled materials for the substrate are more than offset by the expense of higher coating weights.

With reference to FIG. 2, a posterboard 20 according to the invention herein is shown in section. The posterboard 20 generally comprises a paperboard substrate 22 that is coated on its outside surfaces with base coat layers 24 and 26. A top coat layer 30 is applied over the base coat 24 and a second top coat layer 32 is applied over the base coat 26.

The substrate 22 is a paperboard, typically about 16 points thickness, and in a range of about 8 to 20 points thickness, and may be made from a mixture of virgin fiber and pulp from recycled materials as is known. However, it is preferably made from recycled materials or substantially recycled materials, preferably without bleach, to provide an ecologically advantageous product. As noted above, such paperboard may have an uneven dark or mottled surface that would ordinarily require substantial coating layers 14 and 16, such as described above with respect to the prior art posterboard 10.

However, the posterboard 20 is characterized by two coating layers on each of its surfaces, namely base coats 24, 26 and top coats 30, 32. This has proven advantageous in providing desirable smoothness, color intensity and brightness, even over paperboard substrate including substantially all recycled materials, at an economical cost.

The base coat layers 24 and 26 are preferably a clay and binder coating. The base coating preferably includes a whitening pigment, especially when used over a darker mottled substrate, and the binder is preferably a latex. More particularly, suitable base coat layers contain 32 parts No. 1 clay, 20 parts No. 2 clay, 9 parts calcine clay, 26 parts ground or precipitate CaCO₃, 7 parts plastic pigment, 21 parts starch, 2 parts polyvinyl alcohol, 14 parts latex and a dispersant to surfactant. About 7 parts TiTO₂ may be included as a whitener.

The base coat layers 24, 26 are applied at coating loads, necessary to achieve a substantially smooth surface with substantially even color coverage to act as a base layer for light-weight top coats 30 and 32. The coating weights for the base coats 24, 26 may be as low as 3-5 lbs or as high as 8-10 lbs depending on the requirements imposed by the substrate 22. The base coats 24, 26 are preferably applied with an air-knife for smoothness but may be blade-coated.

With reference to FIG. 3, another posterboard 40 is shown having first base coats 44, 45 and second base coats 46, 47. These base coats may have the composition described above, and are provided in two layers to compensate for especially uneven and poorly colored substrate 42. This substrate 42 is made of all or substantially all recycled materials. Coating weights may be 5-8 lbs for each of the base coats 44-47, or 10 or more lbs total coating weights for each set of base coats 44, 46 and 45, 47.

When two base coats 44, 46 and 45, 47 are utilized, the first base coats 44, 45 may be blade coated and the second base coats 46, 47 are preferably air-knife coated, to improve the smoothness of the surface prior to applying the top coat. As noted above, the base coats may have different weights.

The top coats 30 and 32 also contain color pigmentation or dyes, and in the most advantageous aspect of the invention, fluorescent pigments, in a binder and clay coating composition. More particularly, a suitable fluorescent top coat has 70 parts precipitated CaCO₃, 15 parts clay, 38 parts fluorescent pigment, 4 parts addition color dye as required, 23 parts latex and 1 part Surfynol surfactant. The top coats 30 and 32 are applied at a coating rate of 3 to 7 pounds per 500 sheets of standard posterboard, which is 25×38 inches, and preferably at 3-5 lbs, wherein a substantial reduction of pigments is realized with respect to the total pigment used prior art coated posterboard.

This also achieves comparable color intensity and brightness to a prior art posterboard 10 coated with the fluorescent top coat at a rate of over 7 pounds, on a paperboard substrate 12 made from pulp with a high virgin fiber content. The foregoing resulted in substantial economies in making the posterboard, and especially fluorescent posterboard, and in a more ecologically friendly product.

Accordingly, colored posterboards, which may be fluorescent posterboards to maximize the advantages of the invention, have been described that admirably achieve the objects of the invention herein. It will be appreciated that the posterboards described are preferred embodiments of the invention, and that various changes may be made without departing from the spirit and scope of the invention, which is as set forth in the following claims.

I claim:

1. A colored posterboard comprising:
A) a paperboard substrate having a thickness in the range of 0.008-0.020 inches;
B) at least one base coat including clay and a binder applied to at least one side of the paperboard substrate at a coating weight sufficient to substantially fill and smooth surface irregularities of the paperboard substrate and to substantially cover dark or mottled coloration of the paperboard substrate; and
C) a top coat applied over the base coat at a coating weight of 3-7 lbs, the top coat including clay, binder, and color pigments in sufficient amount to provide an evenly colored surface of the posterboard.

2. A colored posterboard as defined in claim 1 wherein the paperboard substrate is provided with at least one base coat and at least one top coat on both sides thereof.

3. A colored posterboard as defined in claim 2 wherein the top coats contain fluorescent pigments to form a fluorescent colored posterboard.

4. A colored posterboard as defined in claim 2 wherein the base coats include a whitener

5. A posterboard as defined in claim 3 wherein the substrate is made of all or substantially all recycled materials.

6. A posterboard as defined in claim 5 wherein one base coat is applied to each side at a coating weight of 3 to 10 lbs.

7. A posterboard as defined in claim 5 wherein two base coats are applied to each side of the paperboard substrate.

8. A posterboard as defined in claim 7 wherein the first applied base coat is blade coated and the second applied base coat is air-knife coated.

9. A posterboard as defined in claim 7 wherein the coating weights of the two base coats on each side of the posterboard have a combined coating weight of 10 or more pounds.

10. A posterboard as defined in claim 1 wherein the color pigment of the top coat is fluorescent color pigment.

11. A posterboard as defined in claim 1 wherein the base coat includes a whitener.

12. A posterboard as defined in claim 1 wherein the substrate is made of all or substantially all recycled materials.

13. A posterboard as defined in claim 1 wherein one base coat is applied to each side of the paperboard substrate at a coating weight of 3 to 10 lbs per base coat.

14. A posterboard as defined in claim 1 wherein two base coats are applied to each side of the paperboard substrate.

15. A posterboard as defined in claim 14 wherein the first applied base coat is blade coated and the second applied base coat is air-knife coated.

16. A posterboard as defined in claim 15 wherein the coating weights of the two base coats on each side of the paperboard substrate have a combined coating weight of 10 or more pounds.

17. A posterboard as defined in claim 1 wherein the top coat is applied at a coating weight of 3 to 5 lbs.
